(19) United States
(12) Patent Application Publication
(10) Pub. No.: US 2012/0192380 A1
(43) Pub. Date: Aug. 2, 2012

(54) HINGE ASSEMBLY

(75) Inventors: LIAN-CHENG HUANG, Shenzhen City (CN); SHEN LI, Shenzhen City (CN)

(73) Assignees: HON HAI PRECISION INDUSTRY CO., LTD., Tu-Cheng (TW); HONG FU JIN PRECISION INDUSTRY (Shenzhen) CO, LTD., Shenzhen City (CN)

(21) Appl. No.: 13/219,859

(22) Filed: Aug. 29, 2011

(30) Foreign Application Priority Data
Jan. 28, 2011 (CN) 201110031582.6

(51) Int. Cl. E05D 11/10

(52) U.S. Cl. 16/319

(57) ABSTRACT

A hinge assembly includes a sleeve, a rotation shaft, and a sealing subassembly. The rotation shaft is partially received in the sleeve. The sealing subassembly seals the sleeve. The sleeve defines a pivot hole, and an inner side wall defining the pivot hole defines a restricting portion. The rotation shaft has a shaft portion and a buffer portion extending from a side wall of the shaft portion. The shaft portion is received in the pivot hole of the sleeve, and the buffer portion is received in the restricting portion of the sleeve. Damping oil is used between the inside of the sleeve and the rotation shaft.

### BACKGROUND

1. Technical Field

The present disclosure generally relates to hinge assemblies, and particularly, to a hinge assembly filled with damping oil.

2. Description of the Related Art

A hinge used in an electronic device, such as a washing machine, generally has a torsion spring. The hinge rotatably connects a cover to a main body. When a user opens the cover relative to the main body, the torsion spring provides an elastic force to help the user open the cover. When the cover is closed it can hit against the main body quite forcefully and cause damage.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a hinge assembly.

FIG. 2 is an exploded, isometric view of the hinge assembly of FIG. 1.

FIG. 3 is a cross-section view of the hinge assembly of FIG. 1, taken along line III-III.

FIG. 4 is a cross-section view of the hinge assembly of FIG. 1, taken along line IV-IV.

### DETAILED DESCRIPTION

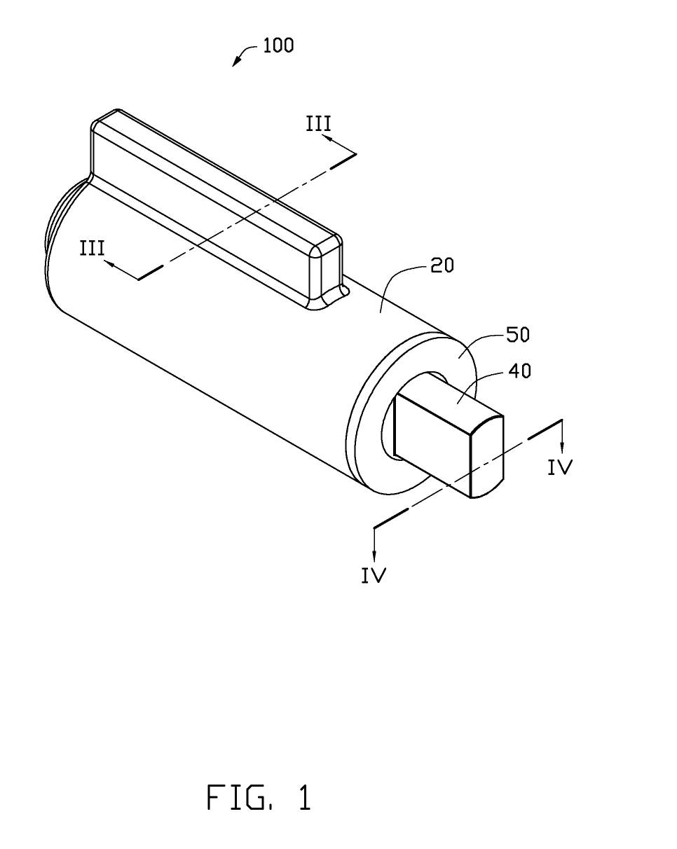

Referring to FIG. 1, an embodiment of a hinge assembly 100 includes a sleeve 20, a rotation shaft 40, and a sealing subassembly 50. The rotation shaft 40 is partially received in the sleeve 20, and the sleeve 20 is sealed by the sealing subassembly 50.

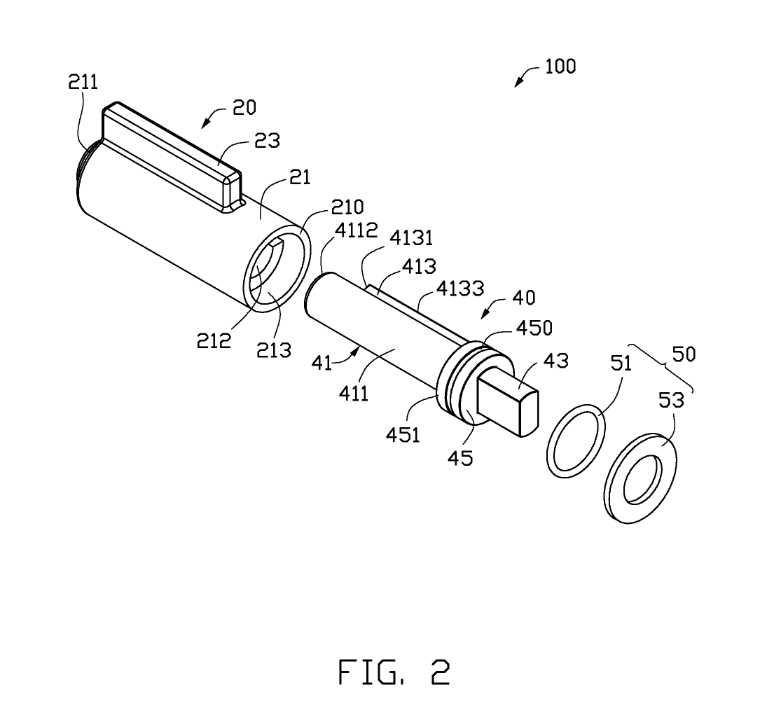

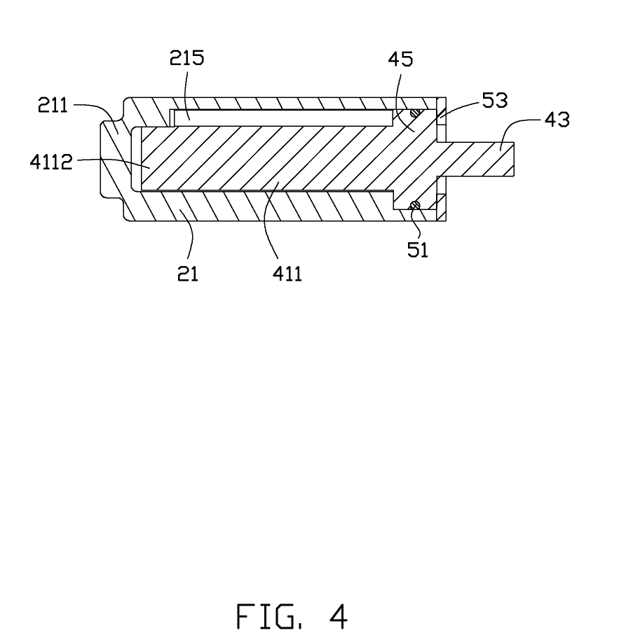

Referring to FIGS. 2 through 4, the sleeve 20 includes a main portion 21 and a connecting portion 23. The main portion 21 is substantially cylindrical, and includes a first end 211 and a second end 212 opposite to the first end 211. The main portion 21 defines a pivot hole 210 extending from the first end 211 to the second end 212 along an axis of the main portion 21. The second end 212 defines a receiving groove 213 communicating with the pivot hole 210. The main portion 21 comprises a circumferential wall defining the pivot hole 210. The circumferential wall has a first part and a second part with a thickness larger than that of the first part along a radial direction of the main body 21. The inner face of the first part of the circumferential wall of the main body 21 is depressed outwards relative to the inner face of the second part along the radial direction to define a restricting portion 215 along the axis of the main portion 21. The restricting portion 215 has a curved side surface 2151 at the inner face of the first part of the circumferential wall, a first restricting surface 2152, and a second restricting surface 2153. The first restricting surface 2152 and the second restricting surface 2153 are respectively connected to opposite ends of the side surface 2151. The connecting portion 23 is a substantially rectangular bar extending from the outer surface of the main portion 21.

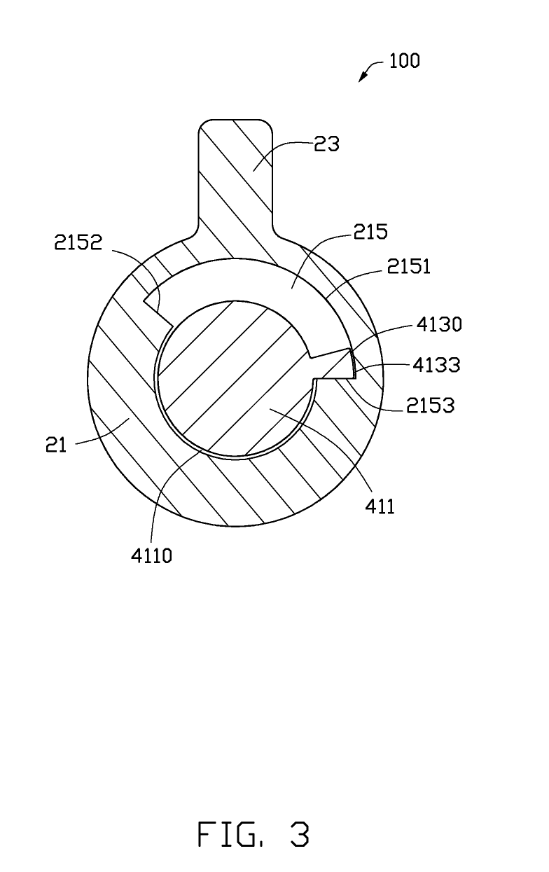

The rotation shaft 40 includes a shaft body 41, a connecting end 43, and a flange 45 connecting the shaft body 41 to the connecting end 43. The shaft body 41 includes a shaft portion 411 and a buffer portion 413 extending from a periphery wall of the shaft portion 411. The shaft portion 411 is substantially cylindrical, and is received in the pivot hole 210 of the sleeve 20. The shaft portion 411 is slightly narrower than the pivot hole 210, i.e., the shaft portion 411 has a radius slightly less than that of an imaginary cylinder defined by the inner face of the second part of the circumferential wall of the sleeve 20, and thus a first gap 4110 is defined between the inner face of the second part of the circumferential wall of the sleeve 20 and an outer face of the shaft portion 411 (see FIG. 3). The shaft portion 411 has a connecting end 4112. The buffer portion 413 extends parallel to the shaft portion 411. The buffer portion 413 includes two end surfaces 4131 and a curved surface 4133 connecting the two end surfaces 4131. The buffer portion 413 is received in the restricting portion 215 of the sleeve 20, and a second gap 4130 is defined between the curved side surface 2151 inside the sleeve 20 and the curved surface 4133 of the buffer portion 413 (see FIG. 3). The flange 45 is received in the receiving groove 213 of the sleeve 20, and includes a curved side surface 451. The side surface 451 defines an annular positioning groove 450.

The first gap 4110 and the second gap 4130 are filled with damping oil to create friction between the inner faces of the sleeve 20 and the outer face of the rotation shaft 40 when the rotation shaft 40 rotates relative to the sleeve 20.

The sealing subassembly 50 is configured for sealing the damping oil in the sleeve 20, and includes a sealing ring 51 and an annular sealing cover 53. The sealing ring 51 is fitly received in the positioning groove 450. The sealing cover 53 is fixed to the second end 212 and seals the sleeve 20. In the illustrated embodiment, both the sleeve 20 and the sealing cover 53 are made of plastic materials, and thus the sleeve 20 and the sealing cover 53 can be fixed together by a hot melting method, such as ultrasound hot melting. It should be understood that, the sleeve 20 and the sealing cover 53 may be fixed together by other methods. For example, if both the sleeve 20 and the sealing cover 53 are made of metal, the sleeve 20 and the sealing cover 53 can be welded together.

In assembly of the hinge assembly 100, the damping oil is placed in the sleeve 20. The sealing ring 51 is received in the positioning groove 450 of the rotation shaft 40, and then the shaft body 41 is inserted into the sleeve 20, with the shaft portion 411 being received in the pivot hole 210, the buffer portion 413 being received in the restricting portion 215, and the flange 45 together with the sealing ring 51 being received in the receiving groove 213. Therefore, the damping oil fills the first gap 4110 and the second gap 4130. The sealing ring 51 is between the flange 45 and the sleeve 20, thereby sealing in the damping oil. The sealing cover 53 is fixed to the second end 212 of the sleeve 20. After the hinge assembly 100 is assembled, the connecting end 43 is connected to a main body (not shown) of an electronic device (not shown), and the connecting portion 23 is connected to a cover (not shown) of the electronic device.

When the rotation shaft 40 rotates relative to the sleeve 20, the buffer portion 413 moves in the restricting portion 215. Because of the damping oil in the sleeve 20, friction is generated between the shaft 40 and the inner faces of the sleeve 20. As a result, the cover will move more slowly when closed lessening the impact against the main body, and thus the electronic device will have a long service life. The friction between the rotation shaft 40 and the inner faces of the sleeve 20 can be adjusted by adjusting a size of the first gap 4110 and the second gap 4130. A rotating angle of the rotation shaft 40 relative to the sleeve 20 is defined by the first restricting surface 2152 and the second restricting surface 2153. Moreover, the hinge assembly 100 utilizes the sealing ring 51 and the sealing cover 53 to seal in the damping oil preventing leaks. Therefore, the hinge assembly 100 has a long service life.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A hinge assembly, comprising:
a sleeve;
a rotation shaft partially received in the sleeve; and
a sealing subassembly sealing the sleeve;
wherein the sleeve defines a pivot hole, inner faces of the sleeve defining the pivot hole define a restricting portion, the rotation shaft has a shaft portion and a buffer portion extending from a periphery wall of the shaft portion; the shaft portion is received in the pivot hole of the sleeve, the buffer portion is received in the restricting portion of the sleeve; and damping oil is filled between the sleeve and the rotation shaft.

2. The hinge assembly of claim 1, wherein the rotation shaft further comprises a flange connected to the shaft portion, the sleeve further defines a receiving groove at an end communicating with the pivot hole, and the flange is received in the receiving groove of the sleeve.

3. The hinge assembly of claim 2, wherein the flange defines a positioning groove, the sealing subassembly comprises a sealing ring positioning in the positioning groove of the flange.

4. The hinge assembly of claim 2, wherein the rotation shaft further comprises a connecting end extending from the flange.

5. The hinge assembly of claim 3, wherein the sealing subassembly further comprises a sealing cover fixed to the end of the sleeve defining the receiving groove.

6. The hinge assembly of claim 5, wherein the sealing cover and the sleeve are made of plastic materials, and fixed together by hot melting.

7. The hinge assembly of claim 5, wherein the sealing cover and the sleeve are made of metal materials, and fixed together by welding.

8. The hinge assembly of claim 1, wherein the sleeve comprises a main portion and a connecting portion extending from an outer surface of the main portion.

9. A hinge assembly, comprising:
a sleeve;
a rotation shaft partially received in the sleeve; and
a sealing subassembly sealing the sleeve;
wherein the sleeve defines a pivot hole, a wall of the sleeve defining the pivot hole defines a restricting portion, the rotation shaft has a shaft portion and a buffer portion extending from a periphery wall of the shaft portion; the shaft portion is received in the pivot hole of the sleeve, the buffer portion is received in the restricting portion of the sleeve; a first gap is defined between the shaft portion and the sleeve, and a second gap is defined between the buffer portion and the sleeve, the first gap and the second gap are filled with damping oil.

10. The hinge assembly of claim 9, wherein the rotation shaft further comprises a flange connected to the shaft portion, the sleeve further defines a receiving groove at an end communicating with the pivot hole, the flange is received in the receiving groove of the sleeve.

11. The hinge assembly of claim 10, wherein the flange defines a positioning groove, the sealing subassembly comprises a sealing ring positioning in the positioning groove of the flange.

12. The hinge assembly of claim 10, wherein the rotation shaft further comprises a connecting end extending from the flange.

13. The hinge assembly of claim 11, wherein the sealing subassembly further comprises a sealing cover fixed to the end of the sleeve defining the receiving groove.

14. The hinge assembly of claim 13, wherein the sealing cover and the sleeve are made of plastic materials, and fixed together by hot melting.

15. The hinge assembly of claim 13, wherein the sealing cover and the sleeve are made of metal materials, and fixed together by welding.

16. The hinge assembly of claim 8, wherein the sleeve comprises a main portion and a connecting portion extending from an outer surface of the main portion.
